(19) United States
(12) Patent Application Publication
(10) Pub. No.: US 2013/0176735 A1
(43) Pub. Date: Jul. 11, 2013

(54) LIGHTING APPARATUS

(71) Applicants: Shinobu Kobayashi, Tokyo (JP); Hiroaki Kawashima, Tokyo (JP)

(72) Inventors: Shinobu Kobayashi, Tokyo (JP); Hiroaki Kawashima, Tokyo (JP)

(21) Appl. No.: 13/822,323

(22) PCT Filed: Sep. 21, 2011
(86) PCT No.: PCT/JP2011/072299

§ 371 Date: Mar. 12, 2013

(30) Foreign Application Priority Data
Sep. 21, 2010 (JP) 2010-210710
Feb. 2, 2011 (JP) 2011-020995

(51) Int. Cl. F21V 3/04; F21V 29/00

(52) U.S. Cl. CPC F21V 3/04; F21V 29/20
USPC 362/249.02

(57) ABSTRACT

A lighting apparatus using light-emitting diodes as the light source, which has light-dispersible property, heat dissipation property, excellent waterproof property, durability and shock resistance, giving no local glares, giving soft illumination, and can be used as a guiding light and a garden light, is provided.

The lighting apparatus according to the present invention is so configured that a substrate 3 on which light-emitting diodes 2 are mounted is connected with electricity supply lines 5, the substrate 3 including connecting points with the electricity supply lines 5 is enclosed with silicon resin 6 to which light-dispersible particulates causing scattering of the irradiated light from light-emitting diodes are mixed, and the insulated covertures 7 of the electricity supply lines 5 at the outer periphery of the silicon resin 6 and the portion in the vicinity of said silicon resin are molded with transparent acrylic resin 8.

### FIELD OF THE INVENTION

The present invention relates to a lighting apparatus with excellent light-dispersibility and heat dissipation property, which uses light-emitting diodes as its light source. In particular, the present invention relates to a lighting apparatus adapted to be arranged at a distance to a plurality of extending electricity supply lines, respectively, and to be suitably used as a guiding light and a garden light.

### BACKGROUND ART

Conventionally, a lighting apparatus which is used in a construction site, a plastic greenhouse, a poultry house and the like is configured in such a type that an electric bulb is screwed into a socket that is electrically connected to a light source through a cable. The socket of the waterproof type disclosed in the appended Patent Document 1 for construction use has sufficient waterproof property and durability to be required for a socket. However, a light apparatus which may be provided with further improved waterproof property, durability and shock resistance as a whole is required.

Recently, in views of durability and energy conservation, light-emitting diodes have been used as a light source for lighting apparatuses. Moreover, it is known to fix a light-emitting diode with resins to form a light source unit by molding. For instance, the lighting devices disclosed in the appended Patent Documents 2 through 5 are the ones comprising light-emitting diodes. However, such a lighting device is so simple one just like being made by placing a light-emitting diode module in a small cube and subsequently filling the small cube with resin. Therefore, the resultant lighting device is far different from a light appliance working like an electric bulb. Note that the use of said resin for filling the small cube is objected to fix the light-emitting diode module only and is not intended to obtain complete waterproof property, high durability and shock resistance. Besides, Patent Document 6 is directed to an underwater lighting body, which is a lighting apparatus intended to be used underwater, in which light-emitting diodes are sealed in an air chamber. This underwater lighting apparatus may attain waterproof property to some extent, but it has no pressure resistance that can sufficiently resist the water pressure in deep sea.

### REFERENCE OF THE PRIOR ART

### Patent Documents

[Patent Document 1]: Japanese Unexamined Patent Application Publication No. Hei 6-163132
[Patent Document 2]: Japanese Unexamined Patent Application Publication No. 2009-198597
[Patent Document 3]: Japanese Unexamined Patent Application Publication No. 2009-181808
[Patent Document 4]: Japanese Unexamined Patent Application Publication No. 2008-277116
[Patent Document 5]: Japanese Unexamined Patent Application Publication No. 2003-303504
[Patent Document 6]: Japanese Unexamined Patent Application Publication No. 2008-305837

### SUMMARY OF THE INVENTION

Nevertheless, the lighting apparatuses those which are used in construction sites, plastic greenhouses, poultry houses and the like need to have excellent waterproof property, durability and shock resistance. Namely, damage resistance against bad circumstance, such as construction sites and the like, where lighting apparatuses are handled in rude manners, and even shock resistance against the impact caused by explosion of dynamites are desirably required for such lighting apparatuses. Further, it is desired that a lighting apparatus with complete waterproof property, which allows to block entering of water into the interior of the lighting apparatus and never to cause leakage of electricity even though the lighting apparatus is exposed to rainwater and/or sprinkled water in a construction site or antiseptic solution and/or cleaning solution in a plastic greenhouse, a poultry house and the like, can be provided. Still further, it is also desired that a lighting apparatus capable of exerting waterproof property with such extent of completeness that the lighting apparatus can be used in a pool and underwater and high pressure resistance enough to stand under water pressure even though it is used in deep sea, can be provided.

Therefore, it is an object of the present invention to provide a lighting apparatus using light-emitting diodes as its light source, which has excellent light dispersibility and heat dissipation property, as well as waterproof property, durability and shock resistance.

Further, it is another object of the present invention to provide a lighting apparatus which may emit irradiation of light with no local glares but with soft illumination by virtue of the dispersion of light and is useful as a guiding light and a garden light.

For achieving the objects as described above, the lighting apparatus according to the appended Claim 1 is characterized in that electricity supply lines are connected to substrates to each of those which light-emitting diodes are mounted, a connecting point connecting said substrates, said light-emitting diodes and said electricity supply lines is enclosed with light-permeable thermosetting resin, and a region ranging from the outer periphery of the thermosetting resin to the insulated covertures of the electricity supply lines adjacent to said thermosetting resin is molded with light-permeable thermosetting resin.

As an embodiment according to the present invention, the lighting apparatus claimed in Claim 1 is characterized in that the light-permeable thermosetting resin is prepared by mixing particulates causing dispersion of the irradiated light from the light-emitting diodes to said thermosetting resin matrix.

According to another embodiment of the present invention, the light-permeable thermosetting resin is characterized in that it is prepared by mixing particulates with the particle size causing Mie scattering of the irradiated light from the light-emitting diodes to said thermosetting resin matrix.

According to still another embodiment of the present invention, the light-permeable thermosetting resin is characterized in that it is prepared by mixing the particulates of silicon dioxide to said thermosetting resin matrix.

According to still further embodiment of the present invention, the light-permeable thermosetting resin is characterized in that it is prepared by mixing highly-dispersible silica which comprises fine aggregates resulted from the aggregation and fusion of the particulates of silicon dioxide to said thermosetting resin matrix.

According to still further embodiment of the present invention, said particulate of silicon dioxide is characterized in that it is a spherule having the diameter of 10 to 30 nm, and that said fine aggregate of the highly-dispersible silica, which is resulted from the aggregation of a plurality of said particulates, is a bulky aggregate having the diameter of 100 to 400 nm.

According to still further embodiment of the present invention, said light-permeable thermosetting resin is characterized in that it is light-permeable silicon resin.

According to still further embodiment of the present invention, said light-permeable thermosetting resin is characterized in that it is light-permeable polyester resin.

According to still further embodiment of the present invention, said light-permeable thermosetting resin is characterized in that it is light-permeable epoxy resin.

According to still further embodiment of the present invention, said light-permeable thermosetting resin is characterized in that it is prepared by mixing particulates causing the dispersion of the irradiated light from the light-emitting diodes to said thermoplastic resin matrix.

According to still further embodiment of the present invention, said light-permeable thermoplastic resin is characterized in that it is prepared by mixing particulates with the particle size causing Mie scattering of the irradiated light from the light-emitting diodes to said thermoplastic resin matrix.

According to still further embodiment of the present invention, the light-permeable thermoplastic resin is characterized in that it is prepared by mixing the particulates of silicon dioxide to said thermoplastic resin matrix.

According to still further embodiment of the present invention, the light-permeable thermoplastic resin is characterized in that it is prepared by mixing highly-dispersible silica comprising fine aggregates resulted from the aggregation and fusion of the particulates of silicon dioxide to said thermoplastic resin matrix.

According to still further embodiment of the present invention, said particulates of silicon dioxide is characterized in that it is a spherule having the diameter of 10 to 30 nm, and that said fine aggregate of the highly-dispersible silica, which is resulted from the aggregation of a plurality of said particulates, is a bulky aggregate having the diameter of 100 to 400 nm.

According to still further embodiment of the present invention, said light-permeable thermoplastic resin is characterized in that it comprises transparent acrylic resin.

According to still further embodiment of the present invention, said light-permeable thermoplastic resin is characterized in that it is formed into any of spherical, cylindrical and spindle shape.

According to still further embodiment of the present invention, said light-permeable thermoplastic resin is characterized in that it is formed into either spherical or rectangular solid shape and is placed on a base.

According to still further embodiment of the present invention, said substrate to which said light-emitting diodes are mounted is formed on a heat dissipation ceramic plate.

According to still further embodiment of the present invention, a plurality of said light-permeable thermoplastic resin each of those which enclosing said light-emitting diodes and said substrate are connected to each other at a distance with electricity supply cables.

According to still further embodiment of the present invention, the lighting apparatus is characterized in that an electricity supply line is connected to a substrate to which said light-emitting diodes are mounted, said substrate, said light-emitting diodes and said electricity supply line are enclosed with said thermosetting resin and formed into a spherical shape, and said electricity supply line is withdrawn from one point of said thermosetting resin formed into a spherical shape and connected to the electricity supply cable, and the region from the outer periphery of said spherical thermosetting resin to said electricity supply cable is molded with said light-permeable thermoplastic resin.

According to the present invention, an electricity supply line is connected to a substrate to which light-emitting diodes are mounted, the connecting point connecting said substrates, said light-emitting diode and said electricity supply lines is enclosed with light-permeable thermosetting resin, and the insulated covertures of the electricity supply lines at the outer periphery of said light-permeable thermosetting resin and the portion in the vicinity of said light-permeable thermosetting resin are molded with light-permeable thermoplastic resin, so that the lighting apparatus provided with excellent waterproof property, durability, and shock resistance as well as light dispersibility and equipped with light-emitting diodes as its light source can be achieved. Furthermore, the lighting apparatus according to the present invention can be produced according to a relatively simple process.

Additionally, by virtue of mixing the particulates capable of causing dispersion of irradiated light from said light-emitting diodes to the resin matrix, the lighting apparatus which may give irradiation of light with no local glares but with soft illumination and is applicable for a guiding light and a garden light can be achieved.

### BRIEF DESCRIPTION OF THE DRAWINGS

FIG. 1 A schematic perspective view illustrating the main parts of the lighting apparatus according to Example 1 of the present invention.

FIG. 2 A top view (A) and a front view (B) of the lighting apparatus shown in FIG. 1.

FIG. 3 A top view of the lighting apparatus according to Example 2 of the present invention.

FIG. 4 A top view of the modified example of the lighting apparatus according to Example 2 of the present invention.

FIG. 5 A schematic partially-enlarged view of the transparent synthetic resin according to the present invention.

FIG. 6 A perspective view of the lighting apparatus according to Example 3 of the present invention.

FIG. 7 A perspective view of the lighting apparatus according to Example 4 of the present invention.

FIG. 8 A side view (A), a vertical cross-section (B) and a transverse cross-section at the central part (C) of the lighting apparatus according to Example 5 of the present invention.

FIG. 9 A side view (A), a vertical cross-section (B) and a transverse cross-section at the central part (C) of the lighting apparatus according to Example 7 of the present invention.

### DESCRIPTION OF THE REFERENCE NUMERALS

1, 50, 60: Lighting apparatus
2, 17, 18, 19, 20, 52, 53, 62, 63: Light-emitting diode
3: Substrate
5, 54, 64: Electricity supply line
6, 21, 22, 25: Transparent synthetic resin
7: Insulated coverture
8, 58, 68: Transparent acrylic resin
9, 51, 61: Ceramic heat dissipation plate
10, 27, 43, 57, 67: Electricity supply cable
11: Matrix
12: Particulates of Highly-dispersible silica
15, 16, 51, 61: Ceramic heat dissipation plate
23, 24: Connecting line
30: Guiding light apparatus
40: Garden lighting apparatus
41: Transparent acrylic resin
42: Support
55: Connecting cable
56: Transparent silicon ball
58: Transparent acrylic resin

### DETAILED DESCRIPTION OF THE PREFERRED EMBODIMENTS

Now, the present invention will be described by means of the following embodiments with referring to the appended drawings. It should be noted that, although the following embodiments are preferred examples of the present invention, the present invention is not limited to the following examples and may be applied to various types of lighting apparatuses, including the ones for outdoor installation use, for indoor installation use, for underwater installation use, for the vacuum of space installation use and the explosion-proof type for construction site use and for mining field use.

### EXAMPLES

### Example 1

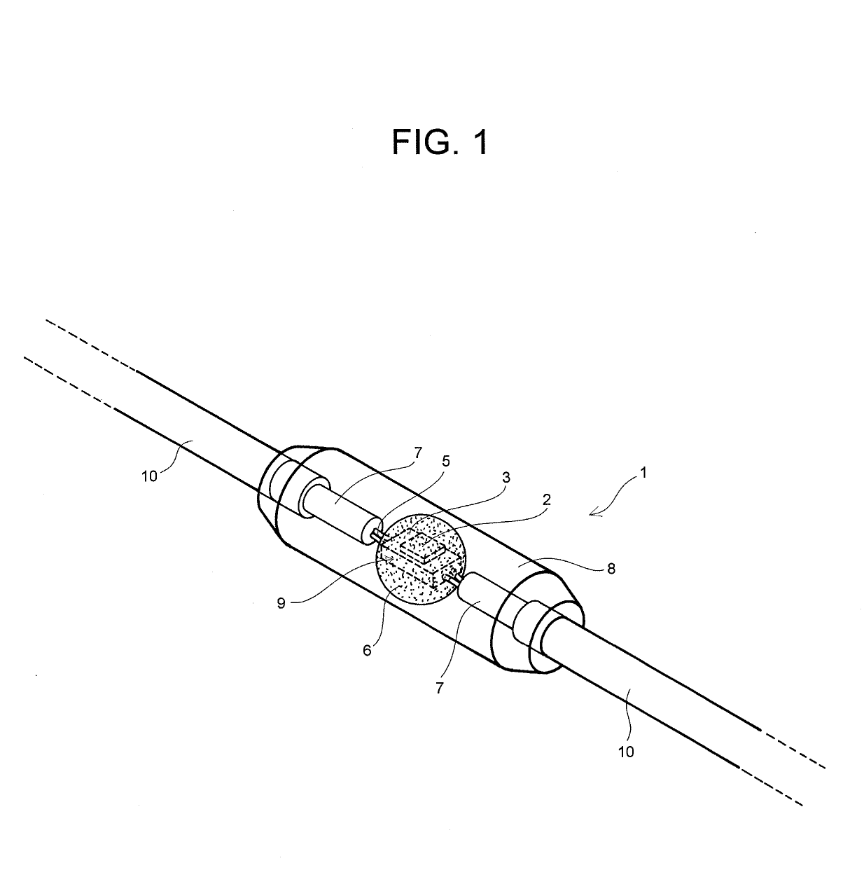

FIG. 1 is a schematic perspective view illustrating the main parts of the lighting apparatus 1 according to Example 1 of the present invention. The lighting apparatus 1 comprises light-emitting diodes 2, substrates 3 on each of those which said light-emitting diode 2 is mounted, electricity supply lines 5 for supplying electricity to the light-emitting diodes 2 via the substrates 3, silicon resin 6 for enclosing the whole of the substrates 3 and the light-emitting diodes 2 including the connecting point connecting the electricity supply lines 5 and the substrates 3, and the outer shell made of transparent acrylic resin 8 which is molded in such a manner that the region ranging from the silicon resin 6 to the insulated covertures 7 covering the adjacent electricity supply lines 5 is embedded in said transparent acrylic resin 8.

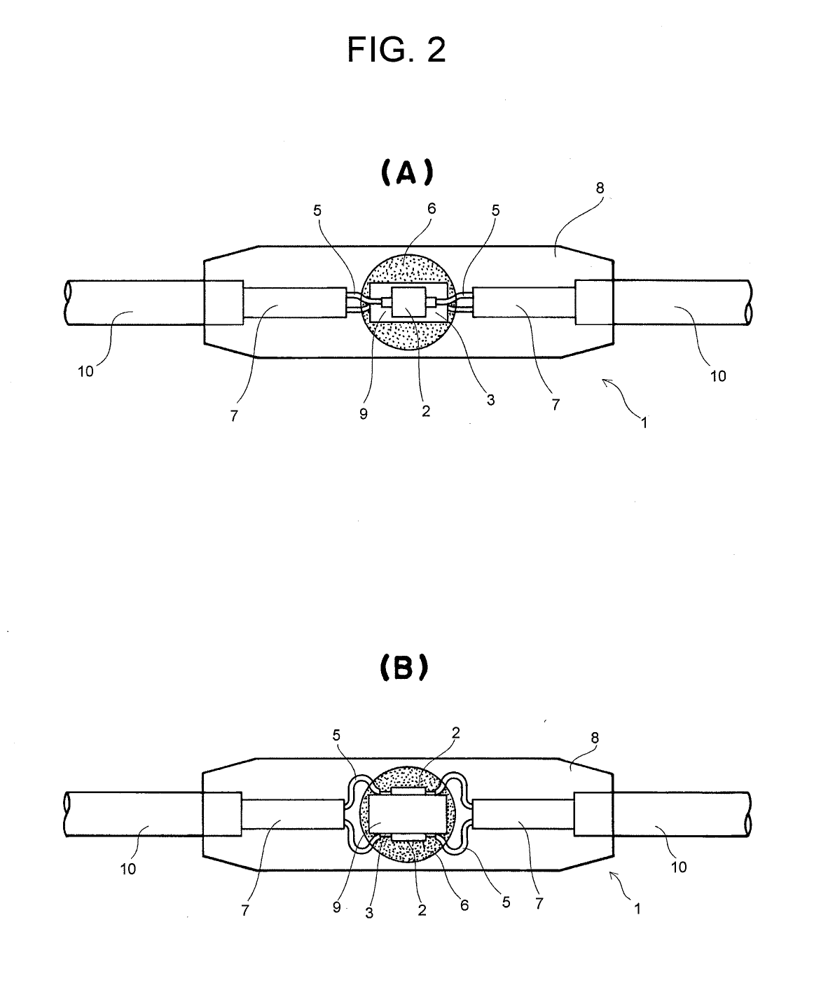

More specifically, the substrates 3 each mounted with a light-emitting diode 2 are formed on both upper and under surfaces of the ceramic heat dissipation plate 9, and the heat generated from the light-emitting diodes 2 is converted by the heat dissipation plate 9 to far infrared rays and is then radiated as electromagnetic waves. The insulated covertures 7 of the electricity supply lines 5 are further enclosed with the electricity supply cable 10 formed with VCT resin insulator. As shown in the top view (A) and the front view (B) in FIG. 2, the electricity supply lines 5 are exposed from the insulated covertures 7 in the vicinity of the ceramic heat dissipation plate 9 and are connected to the substrates (substrate circuits) formed respectively on the upper and under surfaces of the ceramic heat dissipation plate 9. In Example 1, the electricity supply cables 10 covered with VCT resin insulators are closely connected with transparent acrylic resin forming the outer shell in the welding-like state, and the tips of the cables extend from the transparent acrylic resin 8 toward the both sides to connect to the power source (not shown) via an AC adaptor unit, a control unit comprising a constant current control board, etc., a main cable and a rectifier (all are not shown).

The surrounding area of the heat dissipation plate 9 including the connecting point of the light-emitting diodes 2 on the ceramic heat dissipation plate 9 and the electricity supply lines 5 is molded in a spherical shape with silicon resin 6 to form the light irradiation section. Further, with this configuration, the silicon resin 6 as a thermosetting resin is adapted to protect the light-emitting diodes 2 on the ceramic heat dissipation plate 9 and the wirings thereto against the heat generated at molding of the transparent acrylic resin 8 described later.

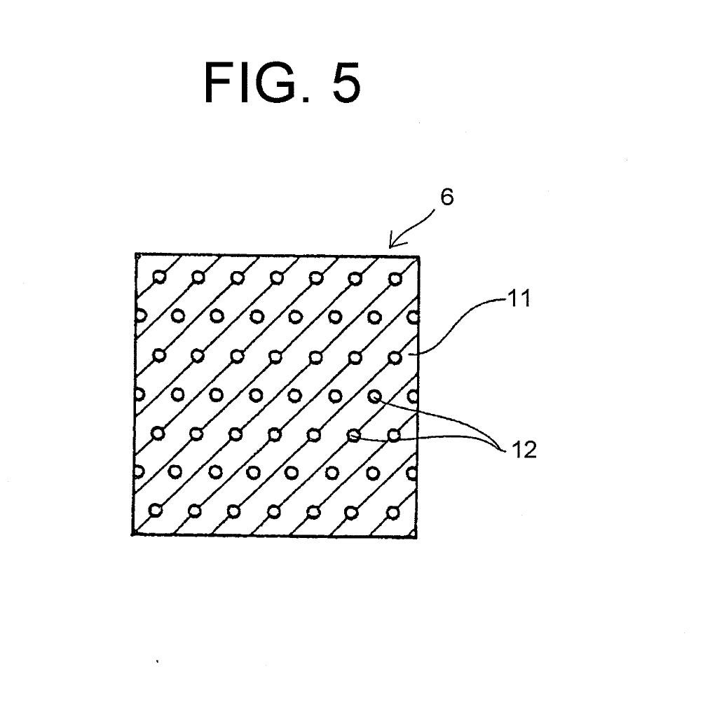

Although said silicon resin 6 may be formed with a common transparent silicon resin, it is formed, in Example 1, with a synthetic resin matrix having light permeability as schematically shown in FIG. 5, e.g. a synthetic resin material in which particulates of highly-dispersible silica as light-dispersible particulates are mixed to transparent silicon resin 11 to be used as the matrix. The silicon resin 6 is a synthetic resin which can sufficiently stand heat generated by the light-emitting diodes 2 and the substrates 3, and as schematically shown in FIG. 5, the granular aggregates 12 of highly-dispersible silica are homogenously dispersed in the transparent silicon resin matrix as the base material. This highly-dispersible silica is generally named as dried silica or fumed silica and is manufactured through combustion hydrolysis of silicon tetrachloride. More specifically, although silicon dioxide obtained by the combustion method may exist in the air in the state of spherical particulates (the diameter of particulate; 10 to 30 nm), however, a plurality of particulates of silicon dioxide aggregate or fuse into a rosary state and form the bulky aggregates (the diameter of particulate; 100 to 400 nm), which are then obtained as the highly-dispersible silica. Note that said particulate which causes the spherical silicon resin 6 to direct the light generated by the light-emitting diodes 2 toward every directions is not limited to said highly-dispersible silica, and any particulate, of which size and the wavelength of the irradiation are either similar to or greater than said highly-dispersible silica and which causes Mie scattering, may be used.

Various advantageous effects can be obtained by adding the highly-dispersible silica described above to a matrix such as silicon. In terms of the irradiating light, when a synthetic resin material comprising silicon base matrix to which highly-dispersible silica is mixed by addition is used, irradiation light impinges on the highly-dispersible silica to cause Mie scattering, whereby producing milky-white colored and well permeable light with improved light directionality and scattering property and soft illumination over the whole light irradiation area, whereas illumination accompanied with local glares as seen in this type of conventional lighting apparatuses does not occur. Besides, the particulate size of the highly-dispersible silica may be adjusted, for example the particulate size may be increased, so that the light directivity toward the front direction of the substrate is improved and adequate light directivity and light scattering property may be secured in accordance with the purpose and location of the intended use. Besides, in view of the physical property, the light irradiation section formed of silicon resin to which highly-dispersible silica has been added attains adequate elasticity and improved shock resistance. Furthermore, the addition of the highly-dispersible silica to silicon may provide the silicon resin with better miscibility, improvement of the surface characteristic, such as prevention of the surface tackiness and shape retention ability during the molding carried out according to injection molding or extrusion molding technique.

The transparent acrylic resin 8 constituting the outer shell, which forms the molding covering the region ranging from the spherical silicon resin 6 molded around the light-emitting diodes 2 and the ceramic heat dissipation plate 9 working as the substrate as well to the area of the insulated covertures 7 of the electricity supply lines 5 adjacent to said silicon resin 6, is formed in either cylindrical or spindle shape in Example 1. Specifically, the spherical silicon resin 6 forming the light irradiation section and the insulated coverture 7 of the electricity supply lines 5 extending toward both diameter directions in the vicinity of said silicon resin 6 are molded with the transparent acrylic resin 8, whereby the electricity supply lines 5 and the silicon resin 6 are integrated, and larger fused area of the insulated coverture 7 and the transparent acrylic resin 8 may be secured so that the lighting apparatus provided with waterproof property, pressure resistance, high explosion-proof property, etc. can be achieved.

With the configuration as described above, light emitted from the light-emitting diodes 2 is scattered to the whole directions from the spherical body by virtue of passing through the spherical silicon resin 6 incorporated with the particulates of said highly-dispersible silica and is also reflected by the outer transparent acrylic resin 8 at the same time so that the lighting apparatus which can provide soft illumination as a whole may be achieved. Besides, molding of the region ranging from the silicon resin 6 to the insulated covertures 7 of the electricity supply lines 5 in the vicinity of said silicon resin 6 with the transparent acrylic resin 8 causes the fusion of the electricity supply cable 10 covered with VCT resin insulator having a melting point of 180° C. with the plasticized acrylic resin having a melting point ranging from 230 to 260° C. so that all of the electricity supply lines 5, the light-emitting diodes 2 surrounded by the silicon resin 6 and the ceramic heat dissipation plate 9 working as the substrate as well became to be both waterproof and dustproof conditions, which makes possible the light apparatus to be efficiently used as a explosion-proof light apparatus and a pressure resistant lighting apparatus to be used underwater. Further, the enclosure of the light-emitting diodes 2 with the elastic silicon resin 6 and further encompassment of said enclosure with the acrylic resin may protect the light-emitting diodes against impact so that the lighting apparatus 1 provided with shock resistance can be achieved. For instance, the lighting apparatus which may be securely used even in the places where waterproof and explosion-proof properties are required, such as a construction site and the interior of a tunnel, can be achieved.

Note that the light-permeable thermoplastic resin forming the outer shell is not limited to the acrylic resin 8, and any resin, e.g. polyethylene, polyethylene terephthalate, polypropylene, poly(vinyl chloride), polycarbonate, etc. can be used as far as such resin has the required light permeability.

### Example 2

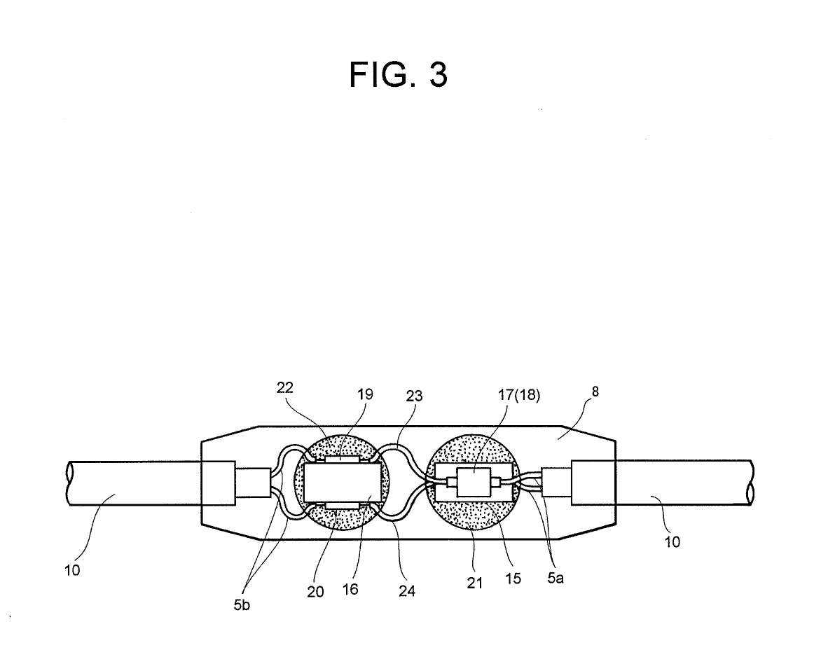

In Example 1, the lighting apparatus is so configured that a ceramic heat dissipation plate and light-emitting diodes attached to both sides of said ceramic heat dissipation plate, respectively, are enclosed in transparent acrylic resin formed by molding. On the other hand, in Example 2, the lighting apparatus is so configured that two ceramic heat dissipation plates 15, 16 are embedded in transparent acrylic resin 8 as shown in FIG. 3. The surfaces of a pair of said ceramic heat dissipation plates 15, 16 on those which the light-emitting diodes are mounted are arranged in the state so as to be perpendicular to each other. Particularly, a substrate circuit is formed on each of the front and rear surfaces of the ceramic heat dissipation plate 15, and the light-emitting diodes 17, 18 are mounted to said front and rear surfaces, respectively, whereas another substrate is formed on each of the front and rear surfaces of the other ceramic heat dissipation plate 16, and the light-emitting diodes 19, 20 are mounted to the upper and under surfaces of the later ceramic heat dissipation plate 16, respectively. Each of the ceramic heat dissipation plates 15, 16 are separately molded in a spherical shape together with the light-emitting diodes 17, 18 and 19, 20 with the transparent synthetic resin 21, 22 explained in Example 1, respectively.

Referring to FIG. 3, it is seen that the light-emitting diodes 17, 18 and 19, 20 mounted respectively on the ceramic heat dissipation plates 15, 16 locating at the left and right sides in the light irradiation section are connected in series with respect to the electricity supply lines being enclosed in the transparent synthetic resin 21, 22. Namely, the substrate circuit formed on the front surface of the ceramic heat dissipation plate 15 is connected by a connecting line 23 with the other substrate circuit formed on the upper surface of the other ceramic heat dissipation plate 16, whereas the substrate circuit formed on the rear surface of the ceramic heat dissipation plate 15 is connected by a connecting line 24 with the substrate circuit formed on the under surface of the other ceramic heat dissipation plate 16. The electricity supply line 5a at the input side is connected to one substrates formed on the front and rear surfaces of one ceramic heat dissipation plate 15 in the transparent acrylic resin 8, whereas the electricity supply line 5b at the output side is connected to the substrates formed on the upper and under surfaces of the other ceramic heat dissipation plate 16. By virtue of configuring the surfaces mounted with the light-emitting diodes of the ceramic heat dissipation plates 15, 16 locating at both sides so that those surfaces are arranged so as to be perpendicular to each other in the transparent acrylic resin 8 as described above, light emitting through the transparent acrylic resin 8 is scattered further efficiently, which results in secured homogeneous light emission around the whole circumference of said transparent acrylic resin 8.

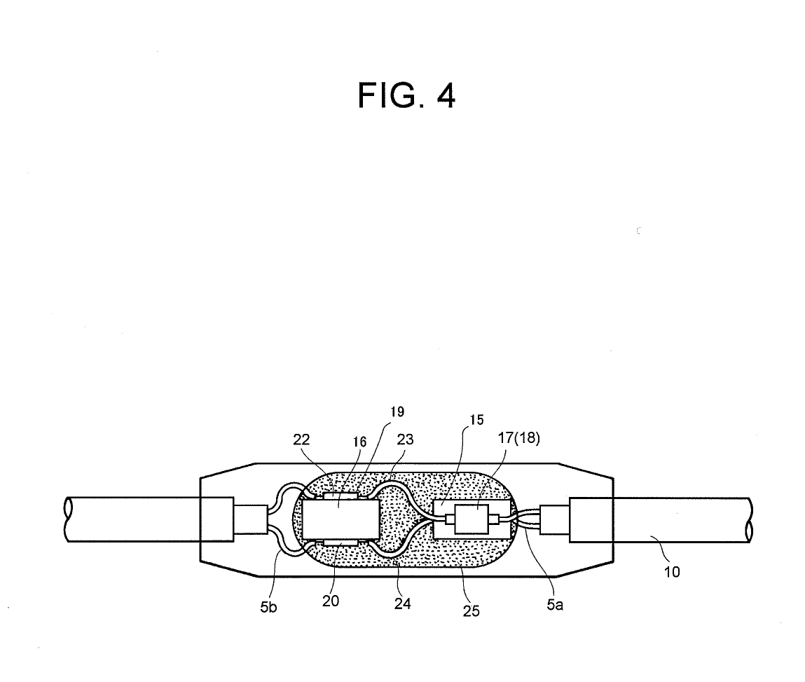

In Example 2, the embodiment wherein two ceramic heat dissipation plates 15, 16 to which a substrate circuit is respectively formed are separately molded in a spherical shape with the transparent synthetic resin 21, 22, is disclosed. However, said embodiment is not necessarily limited to such configuration, and two ceramic heat dissipation plates 15, 16 may be integrated by means of molding using the same transparent synthetic resin 25 as shown in the modified example of FIG. 4. In the case of Example 2, the amount of the transparent synthetic resin material can be minimized as the transparent synthetic resin 21, 22 are formed in a spherical shape in order to embed the respective light-emitting diodes and the substrates therein. In the case of the modified embodiment of Example 4, although the amount of the transparent synthetic resin 25 is slightly increased, the molding of the transparent synthetic resin is facilitated, whereby reduction of the manufacturing cost is achieved because the ceramic heat dissipation plate 15, 16 is integrally molded.

### Example 3

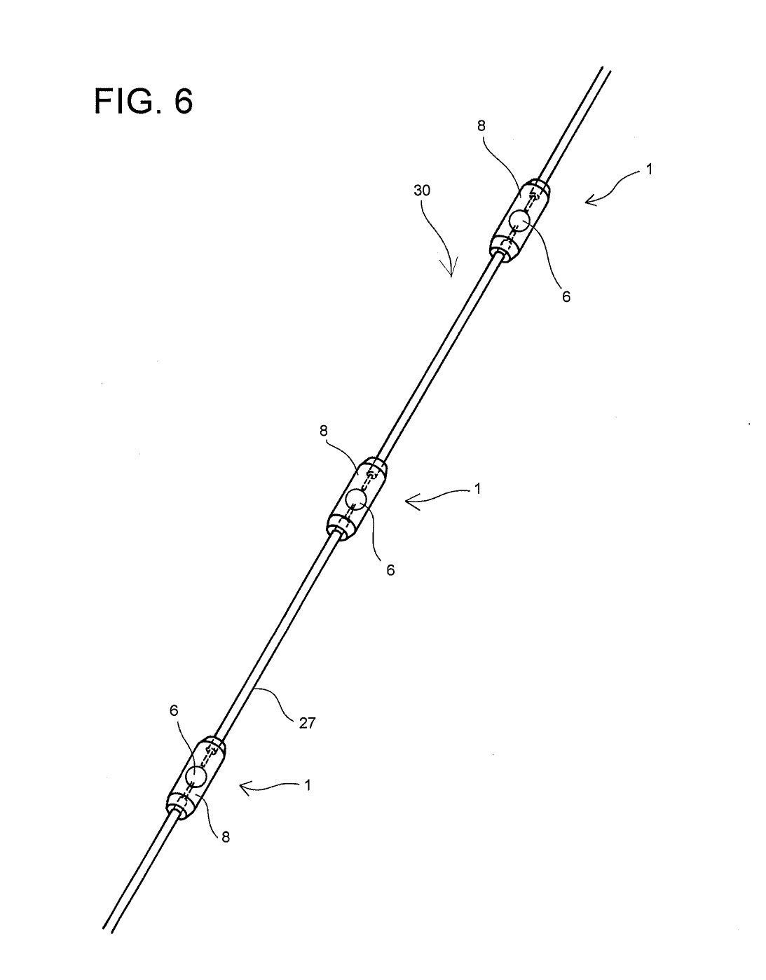

FIG. 6 is a perspective view of the lighting apparatus according to Example 3 of the present invention, which is an embodiment in which a plurality of lighting apparatuses like the one shown in FIG. 1 are connected with one electricity supply cable 27 for configuring a guiding light 30. A plurality of lighting apparatuses 1, each of those which is made by molding the light irradiation section in which a light-emitting diode is enclosed in silicon resin 6 with transparent acrylic resin 8 into a columnar shape are connected in series with the electricity supply cable 27. The resultant lighting apparatus may be installed in a place, such as a road construction site and a field event space, to apply for wide uses as a sign lamp and a guide light. Since the light irradiation section comprising the light-emitting diodes and the silicon resin 6 is completely sealed with the acrylic resin 8, no invasion of rain water or short circuit occurs in the light irradiation section, and a guiding light having strong shock resistance and durability can be achieved. Since the light-emitting diodes are covered with the silicon resin 6 and said covered light-emitting diodes are further covered with transparent acrylic resin 8, no glare light will be emitted so that safeness for car drivers and pedestrians can be secured.

### Example 4

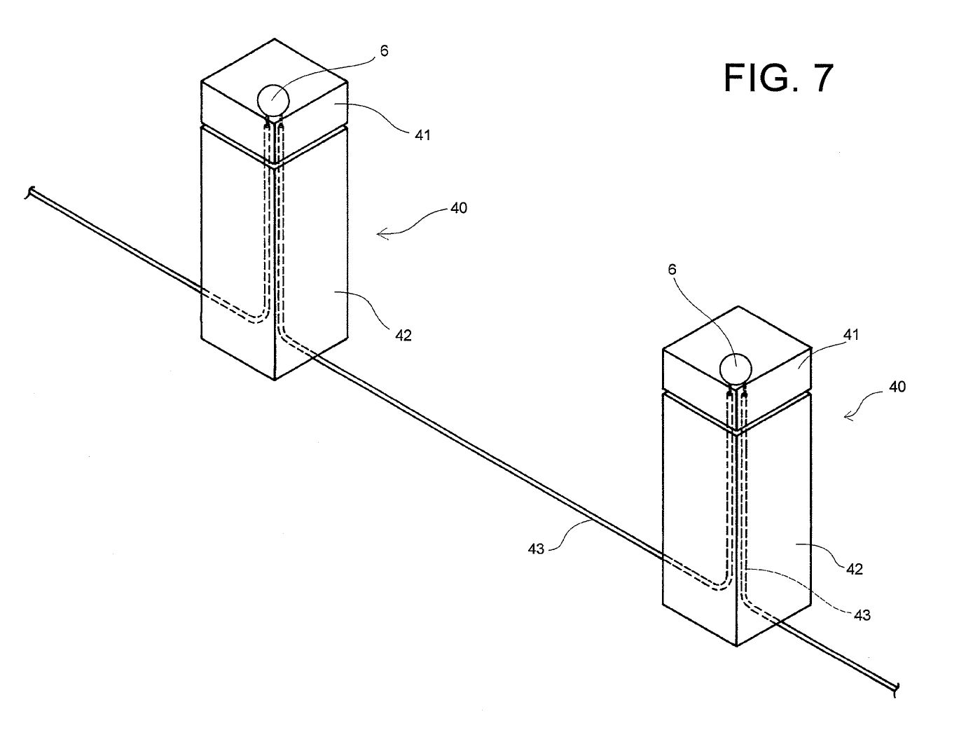

FIG. 7 is a perspective whole view of an example of the lighting apparatus wherein the lighting apparatus according to the present invention is configured as a garden light 40. Light-emitting diode mounted on a substrate is molded into a spherical shape with silicon resin 6 as described in Example 1, and the light irradiation section of this spherically molded resin is further embedded in transparent acrylic resin 41 forming a rectangular solid shape for configuring the light irradiation section. The light irradiation section in a rectangular solid shape is mounted on the top of an appropriate base, e.g. either wooden or concrete-made support 42 stood on the ground in garden. The electricity supply cable 43 withdrawn downward from the substrate for the light-emitting diode through the silicon resin 6 extends from the lower part of the support through the inside thereof onto the ground and is connected to a power source (not shown) via a rectifier (not shown), an AC adaptor unit (not shown), etc. Several pieces of supports 42 and the light irradiation sections mounted thereon may be aligned and connected in series with electricity supply cables 43, as shown in FIG. 7. In this Example 4 as well, since the light-emitting diode and the substrate are sealed in the transparent acrylic resin 41, no invasion into the lighting apparatus occurs even under rainfall and watering. Furthermore, good scattering of light, no local glares, and soft illumination suitable for a garden light and a outdoor light can be securely obtained by virtue of the silicon resin 6 and the outer transparent acrylic resin 41, both enclosing the light-emitting diode. Note that the transparent acrylic resin in Example 4 may be formed in a spherical or circular shape instead of rectangular solid.

### Example 5

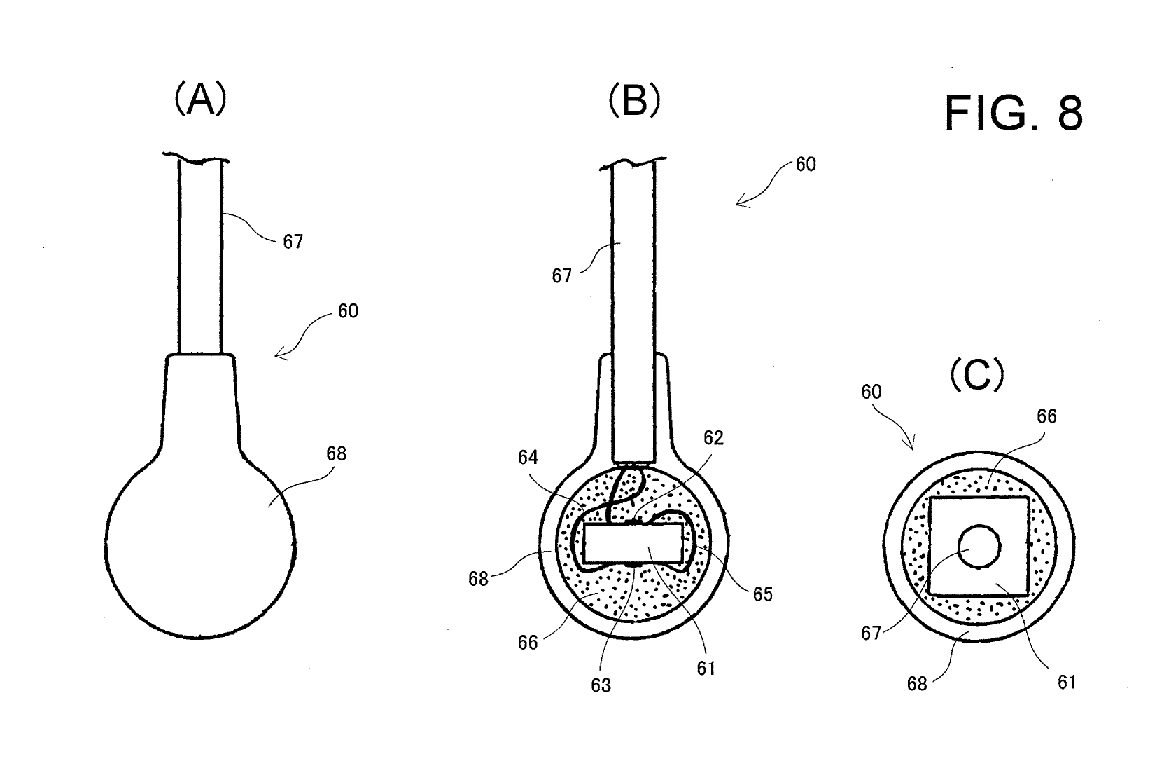

FIG. 8 shows a lighting apparatus 60 according to Example 5 of the present invention, wherein the lighting apparatus is configured as a lighting ball in which a spherical light irradiation section is mounted to the tip of the electricity supply cable. As shown in the vertical cross-section of FIG. 8(B), light-emitting diodes 62, 63 are mounted via the substrates on both upper and under sides of the ceramic heat dissipation plate 61, respectively, and these light-emitting diodes 62, 63 are connected in series with the electricity supply line 64. The reference numeral 65 is a connecting cable that connects the light-emitting diodes 62 and 63 on the upper and under surfaces of the ceramic heat dissipation plate to each other. The ceramic heat dissipation plate 61, the light-emitting diodes 62, 63, the electricity supply line 64 and the connecting cable 65 for the light-emitting diodes are molded in a spherical shape with heat-resisting transparent thermosetting resin, specifically the transparent silicon ball 66, in this Example. A pair of electricity supply lines 64 are withdrawn from one point of the circumference of the transparent silicon ball 66 and are connected to the electricity supply cable 67 covered with VCT insulator.

The region ranging from the outer periphery of the spherical transparent silicon ball 66 to the portion in the vicinity of the tip of the electricity supply cable 67 is integrally molded with transparent thermosetting resin, i.e. transparent acrylic resin 68 in this Example. Heat generated at the molding of the transparent acrylic resin 8 is eased up or blocked by the inner transparent silicon ball 66, so that the light-emitting diodes 62, 63, the electricity supply lines 64 and the connecting cable 65 are protected against the effect by the heat generated at the molding. Note that said thermosetting resin for enclosing the light-emitting diodes 62, 63 is not limited to the transparent silicon ball defined above, and any resin, e.g. transparent polyester resin, transparent epoxy resin and the other light-permeable resins capable of blocking heat generated at molding of the outer shell resin, may be used.

As described above, the transparent silicon ball 66 in Example 5 has function of protecting the interior light-emitting diodes 62, 63 against heat generated at molding the outer shell. Further, the transparent silicon ball 66 is incorporated with light-scattering material comprising particulates which disperse the irradiated light from the light-emitting diodes 62, 63. As the light-scattering material, said particulates having the particle size capable of causing Mie scattering of the irradiated light from the light-emitting diodes 62, 63, the particulates of silicon dioxide, or highly-dispersible silica comprising fine aggregates which is resulted from aggregation and fusion of the particulates of silicon dioxide are used. As the highly-dispersible silica, e.g. bulky aggregates with particle size of 100 to 400 nm, which is resulted in due to the aggregation of plural particulates of silicon dioxide with the particle size of 10 to 30 nm, may be used.

Similarly in Example 5, the region ranging from the transparent silicon ball 66 to the electricity supply lines 57 is integrally molded with said acrylic resin 68 forming the outer shell, the electricity supply lines 64 are not exposed, and waterproof property is provided to the lighting apparatus securely. In addition thereto, excellent pressure resistance and explosion-proof property are provided to the lighting apparatus as well because the light irradiation section is formed in a spherical shape, so that a safe lighting apparatus can be achieved. The incorporation of light-scattering material to the acrylic resin for forming the outer shell provides the light passing therethrough with better directivity and diffusibility, which consequently exert soft illumination as a whole, whereby useful lighting apparatuses to be used as not only a room light but also a lighting apparatus for outdoor use and adapted to be placed anywhere in the field.

In all of the examples described above, the transparent synthetic resin to be used for enclosing the ceramic heat dissipation plates on those which light-emitting diodes and substrates are mounted is formed with transparent silicon resin mixed with light-dispersible particulates causing Mie scattering and the exterior thereof is molded with a light-permeable thermoplastic resin, such as transparent acrylic resin. However, the present invention is not limited to such configurations. For instance, said transparent synthetic resin for enclosing the ceramic heat dissipation plates may be made of a highly-transparent resin other than transparent silicon resins, such as light-permeable polyester resins and epoxy resins, for achieving higher illuminance and gorgeous Mie scattering. Besides, instead of mixing the light-dispersible particulates to the transparent silicon resin for enclosing the heat dissipation plates forming the light-emitting diodes and the substrates, light-permeable synthetic resin (thermosetting synthetic resin) is used for only protecting the inner light-emitting diodes against the thermoplastic resin at the time of molding of resin forming the outer shell of the lighting apparatus, and a light-scattering material, particularly light-dispersible particulates causing Mie scattering or highly-dispersible silica may be mixed to the transparent synthetic resin forming the outer shell. The embodiment employing the configuration like this will now be explained in the following.

### Example 6

Although the lighting apparatus defined in Example 6 has same configuration as those described in Examples 1 through 7. However, in this Example, the synthetic resin for enclosing light-emitting diodes 2, the substrates 3 and ceramic heat dissipation plates 9 (see FIG. 1) carrying the substrates is made of light-permeable thermosetting resin, e.g. light-permeable silicon resin, light-permeable polyester resin, or light-permeable epoxy resin, and light-diffusible material, namely the particulates causing Mie scattering, is not incorporated, and light-permeable resin for protecting light-emitting diodes and the wirings against heat generated at molding the transparent acrylic resin for the outer shell is used. Further, as transparent synthetic resin to be molded over the exterior of the synthetic resin enclosing the ceramic heat dissipation plates, light-permeable thermoplastic resin, e.g. transparent acrylic resin 8 (see FIG. 1) is used, and a light-dispersible material is mixed to said light-permeable thermoplastic resin.

More particularly, particulates having the particle size that causes Mie scattering of the irradiated light from light-emitting diodes, e.g. the particulates of silicon dioxide with the particle size of 10 to 30 nm are mixed to the light-permeable thermoplastic resin forming the outer shell. As the other light-dispersible material to be mixed to the light-permeable thermoplastic resin forming the outer shell of the lighting apparatus in Example 6, said highly-dispersible silica comprising particulates resulted from the aggregation and fusion of the particulates of silicon dioxide can be used. As said particulates of highly-dispersible silica, e.g. bulky aggregates with the particle size ranging from 100 to 400 nm resulted from the aggregation of the particulates of silicon dioxide with the particle size ranging from 10 to 30 nm may be used.

The mixing of said highly-dispersible silica to the outer shell of the lighting apparatus urges irradiated light to collide against said highly-dispersible silica to cause Mie scattering, whereby light with milky-white-colored, good light permeability, improved directivity and scattering property, and providing soft illuminance over the whole irradiated area is provided, but giving no local glare, which is problematic for this type of conventional lighting apparatuses. Further, the particle size of the highly-dispersible silica may be adjusted, e.g. it is increased to the greater size, for increasing the directivity of light toward the front of the substrate and for securing appropriate directivity and scattering property in accordance with the purpose for the use and the place to be used.

### Example 7

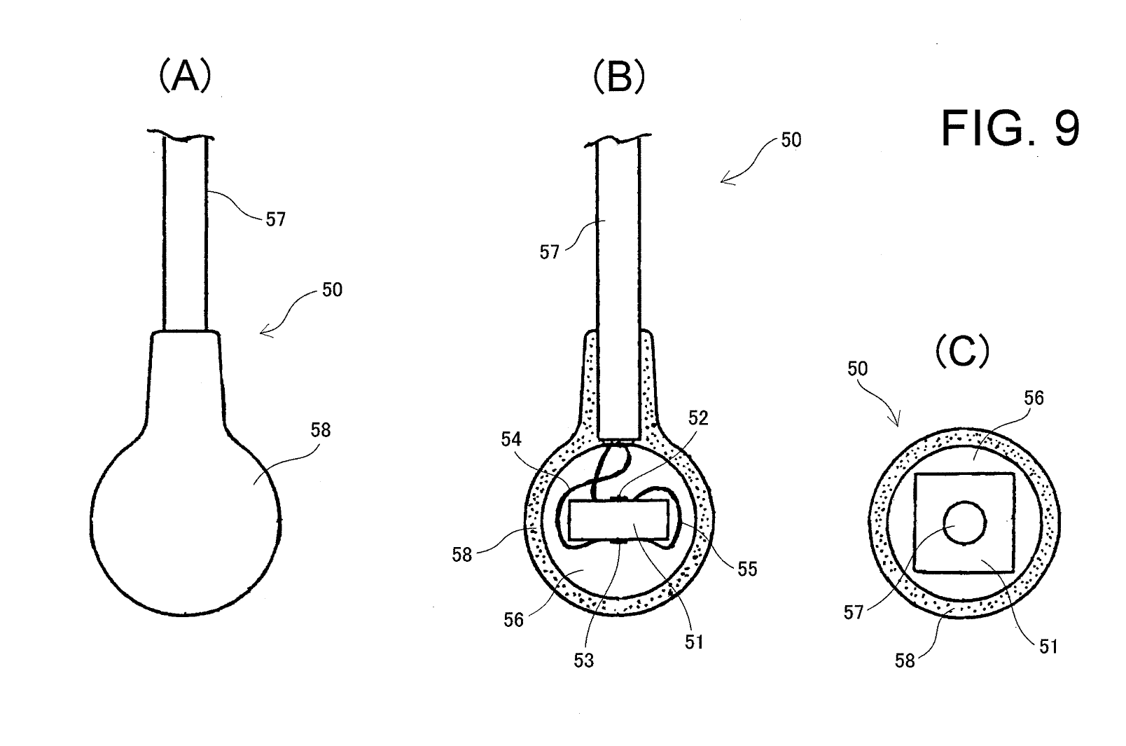

FIG. 9 shows the lighting apparatus 50 according to Example 7 of the present invention, wherein the lighting apparatus is configured as an illumination ball in which a spherical light irradiation section is provided to the tip of the electricity supply cable. As shown in the vertical cross-section of FIG. 9(B), light-emitting diodes 52, 53 are mounted respectively on the upper and under surfaces of the ceramic heat dissipation plate 51 via the substrate, and the light-emitting diodes are connected to each other with the electricity supply lines 54 in series. The reference numeral 55 is the connecting cable for connecting the light-emitting diodes mounted on the upper and under surfaces of the ceramic heat dissipation plate to each other. The connecting cable 55 for connecting the ceramic heat dissipation plate 51, the light-emitting diodes 52, 53 and the electricity supply lines 54 is molded in a spherical shape with heat-resistant light-permeable thermosetting resin, particularly a transparent silicon ball 56 in this Example. A pair of electricity supply lines 54 are withdrawn from one point of the circumference of the transparent silicon ball 56 and are connected to the electricity supply cable 57 covered with VCT insulator.

The area ranging from the outer periphery of the spherical transparent silicon ball 56 to the portion in the vicinity of the tip of the electricity supply cable 57 is integrally molded with light-permeable thermoplastic resin, particularly with transparent acrylic resin 58 in this Example. Heat generated at the molding of the transparent acrylic resin 58 is eased up or blocked by the inner transparent silicon ball 56, so that the light-emitting diodes 52, 53, the electricity supply lines 54 and the connecting cable 55 are protected against the effect by the heat generated at the molding. Note that said thermosetting resin for enclosing the light-emitting diodes 52, 53 is not limited the transparent silicon ball defined above, and any resin, e.g. transparent polyester resin, transparent epoxy resin and the other light-permeable resins capable of blocking heat generated at molding of the outer shell resin, may be used.

As described above, the transparent silicon ball 56 in Example 7 has a purpose to protect the interior light-emitting diodes 52, 53 against heat generated at molding the outer shell and it does not contain the light-dispersible material. Besides, in the transparent acrylic resin 58 forming the outer shell of the light irradiation ball, a light-dispersible material comprising particulates causing light dispersion of the irradiated light from the light-emitting diodes 52, 53 is mixed. As the light-scattering material, said particulates having the particle size capable of causing Mie scattering of the irradiated light from the light-emitting diodes 52, 53, the particulates of silicon dioxide, or highly-dispersible silica comprising fine aggregates which are resulted from the aggregation and fusion of the particulates of silicon dioxide may be used. As the highly-dispersible silica, e.g. bulky aggregate with the particle size of 100 to 400 nm, which is obtained by causing the aggregation of plural particulates of silicon dioxide having the particle size of 10 to 30 nm, may be used.

Similarly in Example 7, the region ranging from the transparent silicon ball 56 to the electricity supply lines 57 is integrally molded with said outer shell acrylic resin 58, the electricity supply lines 54 are not exposed, and waterproof property is provided to the lighting apparatus securely. In addition thereto, excellent pressure resistance and explosion-proof property are provided to the lighting apparatus as well because the light irradiation section is formed in a spherical shape, whereby a safe lighting apparatus can be achieved. The incorporation of the light-dispersible material into the acrylic resin forming the outer shell as described above provides better light directivity and diffusibility and allows to exert soft illumination as a whole. Accordingly, the lighting apparatuses useful as not only a room light but also a lighting apparatuses to be placed at any places in the field can be achieved. Note that, although the light-dispersible material is incorporated either to the transparent silicon resin for enclosing the light-emitting diodes or the acrylic resin forming the outer shell of silicon resin in the above-described examples, the light-dispersible material may be incorporated to both of the transparent silicon resin and the transparent acrylic resin to thereby control the intensity of illuminance.

The lighting apparatus according to any one of the examples as described above can exert light directivity and light diffusibility equal to or better than those of the conventional filament electric balls and can be a light apparatus using light-emitting diodes capable of irradiating light toward 360 degrees directions.

1. A lighting apparatus characterized in that electricity supply lines are connected to a substrate on which light-emitting diodes are mounted, a connecting section connecting said substrate, said light-emitting diodes and said electricity supply lines is enclosed with light-permeable thermosetting resin, and the region ranging from the outer periphery of said thermosetting resin to the insulated covertures of the electricity supply lines in the vicinity of said thermosetting resin is molded with light-permeable thermoplastic resin.

2. A lighting apparatus according to claim 1, wherein said light-permeable thermosetting resin is prepared by mixing particulates causing light dispersion of the light irradiated from said light-emitting diodes to said thermosetting resin matrix.

3. A lighting apparatus according to claim 2, wherein said light-permeable thermosetting resin is prepared by mixing particulates having the particle size causing Mie scattering of light irradiated from said light-emitting diodes to said thermosetting resin matrix.

4. A lighting apparatus according to claim 3, wherein said light-permeable thermosetting resin is prepared by mixing the particulates of silicon dioxide to said thermosetting resin matrix.

5. A lighting apparatus according to claim 4, wherein said light-permeable thermosetting resin is prepared by mixing highly-dispersible silica comprising fine aggregates resulted from the aggregation and fusion of the particulates of silicon dioxide to said thermosetting resin matrix.

6. A lighting apparatus according to claim 4, wherein said particulate of silicon dioxide is a spherule with the diameter of 10 to 30 nm and said fine aggregate of said highly-dispersible silica is a bulky aggregate comprising a plurality of said particulates and having the diameter of 100 to 400 nm.

7. A lighting apparatus according to claim 1, wherein said light-permeable thermosetting resin comprises transparent silicon resin.

8. A lighting apparatus according to claim 1, wherein said light-permeable thermosetting resin comprises light-permeable polyester resin.

9. A lighting apparatus according to claim 1, wherein said light-permeable thermosetting resin comprises light-permeable epoxy resin.

10. A lighting apparatus according to claim 1, wherein said light-permeable thermoplastic resin is prepared by mixing particulates causing dispersion of light irradiated from said light-emitting diodes to said thermoplastic resin matrix.

11. A lighting apparatus according to claim 10, wherein said light-permeable thermoplastic resin is prepared by mixing particulates with the particle size causing Mie scattering of irradiated light from said light-emitting diodes to said thermoplastic resin matrix.

12. A lighting apparatus according to claim 11, wherein said light-permeable thermoplastic resin is prepared by mixing the particulates of silicon dioxide to said thermoplastic resin matrix.

13. A lighting apparatus according to claim 12, wherein said light-permeable thermoplastic resin is prepared by mixing highly-dispersible silica comprising fine aggregates resulted from the aggregation and fusion of the particulates of silicon dioxide to said thermoplastic resin matrix.

14. A lighting apparatus according to claim 12, wherein said particulate of silicon dioxide is a spherule with the diameter of 10 to 30 nm, and said fine aggregate of said highly-dispersible silica is a bulky aggregate with the diameter of 100 to 400 nm resulted from the aggregation of a plurality of said particulates.

15. A lighting apparatus according to claim 1, wherein said light-permeable thermoplastic resin comprises transparent acrylic resin.

16. A lighting apparatus according to claim 1, wherein said light-permeable thermoplastic resin is formed in any of spherical, circular and spindle shape.

17. A lighting apparatus according to claim 1, wherein said light-permeable thermoplastic resin is formed in either spherical or rectangular solid shape and is mounted on a base.

18. A lighting apparatus according to claim 1, wherein said substrate on which said light-emitting diodes are mounted is formed on a ceramic heat dissipation plate.

19. A lighting apparatus according to claim 1, wherein a plurality of said light-permeable thermoplastic resin in which said light-emitting diodes and said substrates are enclosed are connected at a distance with electricity supply cables.

20. A lighting apparatus according to claim 1, wherein said substrate on which said light-emitting diodes are mounted is connected with electricity supply lines, said substrates, said light-emitting diodes and said electricity supply lines are enclosed in a spherical shape with said thermosetting resin, said electricity supply cable is withdrawn from one point of said spherical thermosetting resin and is connected to the electricity supply line, and the region ranging from the outer periphery of the said spherical thermosetting resin to said electricity supply cable is molded with said light-permeable thermoplastic resin.
